(19) United States
(12) Patent Application Publication
(10) Pub. No.: US 2001/0052199 A1
(43) Pub. Date: Dec. 20, 2001

(54) Stackable planter

(76) Inventors: Shoshana Klein, Maccabim (IL); Yosef Klein, Maccabim (IL)

Correspondence Address: Brinks Hofer Gilson & Lione, P.O. Box 10395, Chicago, IL, 60610, US

(21) Appl. No.: 09/885,631

(22) Filed: Jun. 20, 2001

(30) Foreign Application Priority Data
Jun. 20, 2000 (IL) 136897

(51) Int. Cl. A01G 9/02

(52) U.S. Cl. 47/65.5

(57) ABSTRACT

A stackable modular planter comprising a pot having a bottom, side walls and open top, the top edge of at least one side wall having a window for plants to extend therethrough, a water permeable partition divides the pot into an upper plant growing chamber and a lower water collecting and draining chamber having an opening in a side wall for draining water therefrom, said pot further including means for integrally supporting a water pump for recycling water from the lower water collecting chamber to the upper plant growing chamber.

### FIELD OF THE INVENTION

The present invention relates to a stackable mobile planter, which can be used individually, or a number of such planters can be placed on top of and/or next to one another and can be modularly arranged to form partitions or columns.

### BACKGROUND OF THE INVENTION

The use of potted plants and flowers for decorating homes and offices has become very popular. Particularly, arrangements in the form of hanging planters have been used extensively. Hanging planters, however, have limitations in that they are generally not stackable and watering the plants is a problems because of drainage of excess water. Usually a plate is attached to the bottom of the planter to receive the excess water. One arrangement for stacking hanging interlocking planters is known from U.S. Pat. No. 4,614,056. U.S. Pat. No. 4,658,541 discloses an arrangement of interlocking planters for use in erecting decorative walls. Israel Patents 55861 teaches an assembly of bottomless elements arranged in a column for use in hydroponics and aeroponics. Israel Patent No. 83060 also discloses a stackable arrangement for growing plants wherein excess water drains from one container to the container below, with a drainage system associated with the lowest container. Israel Patent No. 94686 discloses a column planter comprising a plurality of stacked pots placed in a tank, each pot having a central opening and drainage holes in its bottom with a vertical tube running through the openings of the pots and a pump feeding water from a bottom reservoir through the tube to the top of the column, the water trickling down through the pots back into the tank. All these arrangements provide planters for stacking on top of one another so that water added to the top planter trickles down through the stack to the lowest planter. The individual planters are not modular and are not completely interchangeable nor very suitable for use alone.

U.S. Pat. No. 4,593,490 describes a plurality of planters that may be used free standing or arranged in a bracket assembly to form a hanging garden. The planters comprise a planting chamber, a watering chamber in back of and drainage chambers on the sides of the planting chamber.

DE 2822294 and DE 3220531 disclose planters stackable on top of one another with water trickling from one planter to the one below.

DE 2243762, DE 2701401 and 3115691 disclose having a separate bottom section for collecting water.

DE 1960336 discloses a stackable planter having a window in a wall for plants to grow out of, a funnel shaped opening in another wall for introducing water to the planter, a separate bottom section for collecting water and a perforated partition between the plant growing section and water collecting section. This patent, however, does not teach a planter provided with means for holding a pump for recycling water within the same planter and which can also be used for draining out the water.

It would be advantageous to have a simple stackable modular planter with built-in water collecting and draining means that could be used individually or in any stacked assembly, whether vertically, horizontally or both, and wherein each planter is interchangeable with another one.

### SUMMARY OF THE INVENTION

It is the object of the present invention to provide a simple stackable modular planter with self contained watering and draining means.

Another object of the invention is to provide a simple stackable modular planter for assembling as a column.

Yet another object of the invention is to provide a simple stackable modular planter for assembling as a partition.

Still another object of the invention is to provide a simple stackable modular planter having vertical non-tapered walls useful in assembling non-transparent partitions.

In accordance with this invention there is provided a stackable modular planter comprising a pot having a bottom, side walls and open top, the top edge of at least one side wall having a window for plants to extend therethrough, a water permeable partition divides the pot into an upper plant growing chamber and a lower water collecting and draining chamber having an opening in a side wall for draining water therefrom, said pot further comprising means for integrally supporting a water pump for recycling water from the lower water collecting chamber to the upper plant growing chamber.

Preferably the water permeable partition is removable. The means for supporting a water pump preferably comprise a shaft integrally formed with either a pot wall or with the porous partition. The water pump is preferably a piston type water pump that draws water through a flexible plastic tube extending into the lower water collecting chamber, and dispenses it in the upper plant growing chamber. The flexible plastic tube is held in place in the shaft. In a further preferred embodiment, at least one side wall of the planter is vertical at 90 degrees, enabling planters to be stacked on top of each other and/or adjacent to one another to form a non-transparent partition.

The drainage opening in the side wall may be an ordinary hole which can be plugged with a stopper, or it may comprise a tube or nipple extending out of the side wall that can be clamped, capped or closed by any other means, to control the outflow of water from the drainage chamber. The opening may also be detachably connected to an exterior drainage tube for leading excess water away from the draining chamber into a collection vessel.

The modular planters of this invention are stackable and self supporting, so that they can be assembled to form a column, with one planter on top of another, or a partition, with several planters or columns adjacent to one another. In a preferred embodiment, at least two side walls of the pot are completely vertical, so that a continuous partition can be assembled by placing planters next to and on top of each other without leaving any space between them.

The water permeable partition dividing the container into two chambers may be a net, webbing or rigid perforated board or sheet elevated from the bottom surface. In a preferred embodiment the partition is removable. This can be accomplished, for instance, by supporting the partition above the floor of the water collecting chamber on legs or on horizontal protrusions extending from inside the side walls. The water permeable partition should be strong enough to support soil or other growth and prevent water from accumulating in the plant growing chamber. The partition allows excess water to drain into the collecting and drainage chamber, where it may be drained through the hole in the side wall or stored and recycled.

In a preferred embodiment of the present invention, water is allowed to accumulate in the collecting and draining chamber in order to recycle it by pumping it back into the upper chamber. This can be done a number of times before draining and discarding the water. Even without recycling, there may be an advantage to let the water accumulate in the collecting chamber water for a short period so that vapor rising from the collecting chamber will keep the soil and roots in the planting chamber moist preventing the plants from drying out. Draining of the water from the bottom chamber, according to the invention, can be accomplished either by unplugging the drain hole or by turning the pump head to face out of the pot through the window in the side wall and pumping the water out of the pot.

Each planter is an independent self-contained unit and can be used as such individually for growing plants and flowers, or it can be stacked on top of and/or next to other plants to form vertical and/or horizontal planter configurations. Because of the self-contained modular feature of the planter, every planter can be removed, exchanged or added from or to any planter arrangement. When in a stacked position, flowers or plants grow out of the window sections of the walls and can be watered therethrough as well. In a preferred embodiment, the lower edge of the window may form a protruding lip extending outward to form a funnel to help guide water into the planting chamber. Since each planter has its own draining port, it is not dependent on water coming from another planter located above it and can, therefore, be re-arranged in any stacked configuration desired. In a further preferred embodiment, the drain opening from the collecting and draining chamber leads into a drainpipe extending adjacent the length of a stacked arrangement to channel the excess water into a container resting on the floor or underneath the stack.

### BRIEF DESCRIPTION OF THE DRAWINGS

The present invention will be better understood with reference to the following drawings, in which

FIG. 1 is a perspective view of a planter in accordance with one embodiment of the present invention.

FIG. 2 is a blown up cross-sectional plan view of a planter as in FIG. 1.

FIG. 3 shows another drain stopper in accordance with the invention.

FIG. 4 is a blown up view of an alternative drainage opening shown in A of FIG. 1.

FIG. 5 is a perspective view of an alternative embodiment of a planter in accordance with the present invention.

FIG. 6 illustrates another embodiment of a planter in accordance with the invention.

FIG. 7 shows yet another embodiment of the invention.

FIG. 8 is a top view of the planter of FIG. 7.

FIG. 9 illustrates a column made from the planters of the invention.

FIGS. 10 and 11 illustrate partitions assembled from planters of this invention.

### DETAILED DESCRIPTION OF THE INVENTION

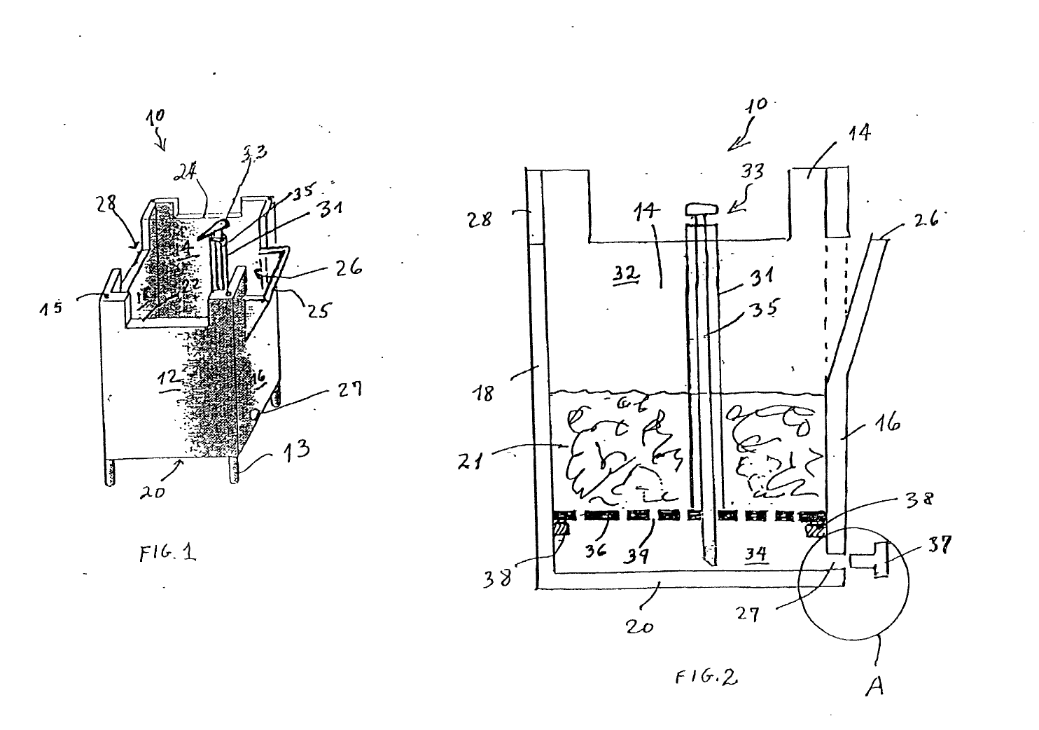

Referring now to FIG. 1, there is illustrated a planter 10 in accordance with the present invention. The planter 10 is shaped in the form of a rectangular container with front and rear walls 12 and 14, side walls 16 and 18, and bottom 20. The top of the container 10 is open. The planter walls 12, 14, 16 and 18 have cut out windows 22, 24, 26 and 28 at the upper edges of the walls respectively, so that when stacked on top of one another, plants and flowers can grow out the windows. The upper edge 25 of cut out window 26 may extend outward from wall 16 providing a funnel shape opening to make it easier to add water to the planter. The planters may have legs 13 or casters 23 (FIG. 5) to make them easily movable from place to place, particularly if they are large and heavy. The top corners of the walls may have holes 15 or recesses into which the legs can fit, for stacking planters one on top of another. At least one wall has a drainage opening 27 near the bottom which may be plugged with a stopper (not shown). A hollow shaft 31 is vertically attached to the interior part of wall 14 and a conventional piston type liquid pump 33 with flexible plastic tube 35 is inserted into the rigid tube 31. The flexible tube 35 reaches to the bottom of the planter (see FIG. 2) and is immersed in the water reaching the bottom, which can then be recycled by pumping it back up onto the plants.

FIG. 2 is a blown up cross-sectional plan view of a planter illustrated in FIG. 1. The planter 10 is divided on the inside into two chambers, an upper planting chamber 32 containing a plant growing medium 21 and a lower collecting and draining chamber 34. The chambers 32 and 34 are separated by a plate 36 resting, for example, on protrusions 38 coming out from the side walls 16 and 18. Alternatively, the plate 36 can rest on legs (not shown). Plate 36 has perforations 39 which allow water to pass through from the planting chamber 32 to the collecting and draining chamber 34 where it is stored, or drained via opening 27 when plug 37 is pulled out. The upper surface of plate 36 serves as the base for holding soil or other growth medium 21 in planter 10. Plants or flowers grown in planter 10 will allow roots to extend through the growth medium 21 until the perforated plate 36 but not beyond, thereby preventing the roots from being immersed in the water accumulating in chamber 34 after watering. Planter 10 also has a pump 33 with a flexible plastic tube 35 inserted in a shaft 31. The shaft 31 is attached to the inside of wall 14 and reaches down to the plate 36, with the flexible tube 35 protruding into the collecting chamber 34. Water accumulating in chamber 34 gives rise to an atmosphere of water vapor surrounding the roots without liquid contact, which is often the cause of root rot. If desired, the excess water accumulated in chamber 34 can be recycled via pump 33. The plants and flowers grow out of the windows 26 and 28 of planting chamber 32 and they may also be watered through these same windows.

Another stopper for plugging up the drain hole 27 is shown in FIG. 3. This stopper comprises a transparent bent tube 39 which can be turned up or down. When it is turned up it shows the water level in the draining chamber and when it is turned down the water is drained out of the draining chamber.

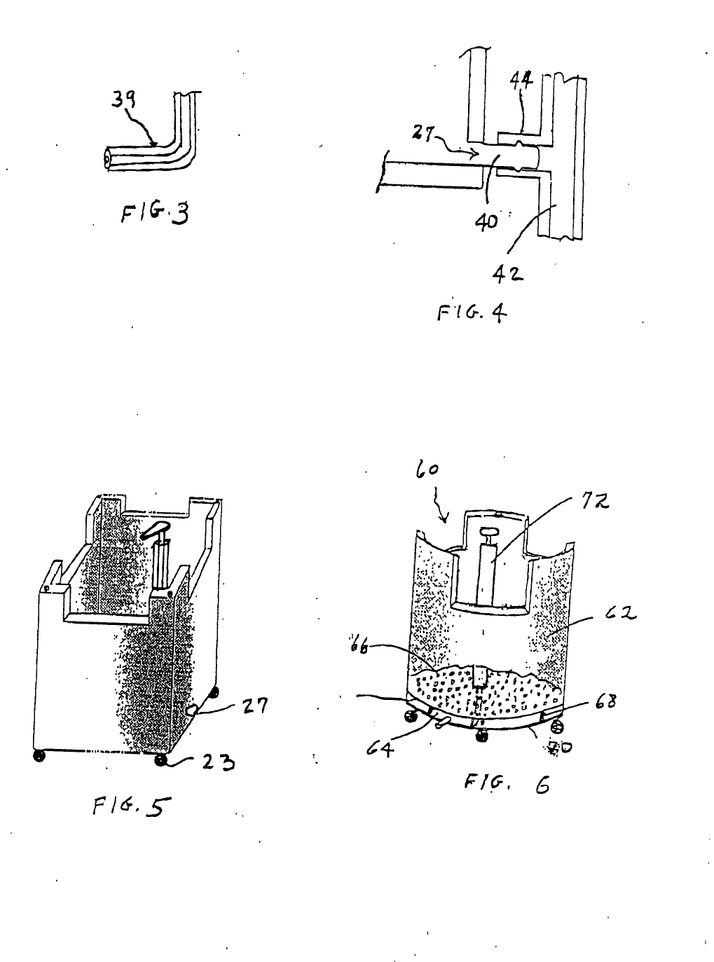

FIG. 4 illustrates an alternative embodiment of the opening 27 in the lower chamber 34 of a planter 10. In this embodiment the opening 27 extends as a nipple 40 which can be reversibly connected to a vertical drain line 42 via connecting tube 44.

FIGS. 5 and 6 illustrate other embodiments of the invention. The round planter 60 can be used either alone or anywhere in a stack of planters and comprises two chambers, a plant growing chamber 62 and a water collecting and draining chamber 64. A perforated plate 66 separates the two chambers, for example, by resting on legs 68 that reach the bottom 70 of the planter 60. A water pump 72 can recycle water from the draining chamber 64 to the plant growing chamber 62 or pump it out of the planter.

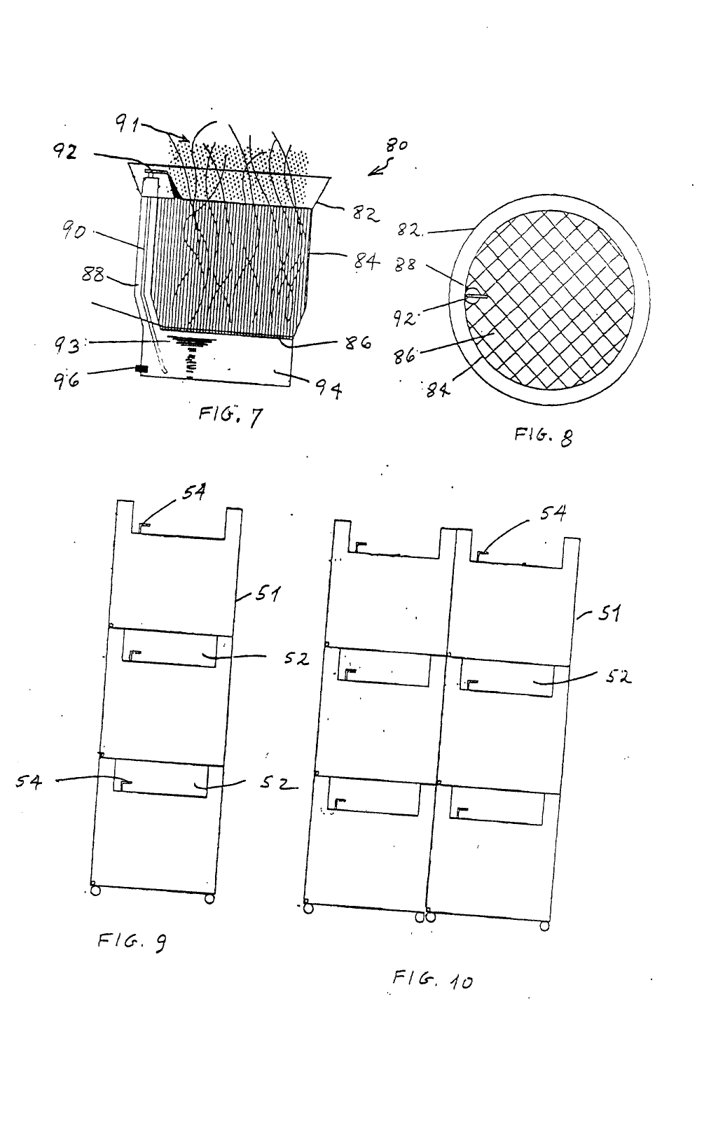

FIGS. 7 and 8 illustrate another planter 80 in accordance with this invention. This planter 80, comprises an outer shell 82 which may be made of plastic or earthenware and an insert 84 having a water permeable bottom 86. The insert 84 has integrally formed a shaft 88 for holding a water pump 90 whose upper end terminates in a piston type dispenser head 92 above the shaft 88. When watering or spraying plants 91 growing in this planter, the water will trickle down 93 into a water collecting section 94 from where it can be drained out by opening plug 96, or it maybe recycled via the pump 90. The planter may also be drained of excess water by removing the entire insert 84 from the outer shell 82 together with the plants and draining the excess water from the shell 82. The pump 90 may be of the kind commonly used to dispense liquid soap and cleaning solutions. This pump 90 can also be used to drain the excess water away from the planter by reversing the direction of the dispensed head 92.

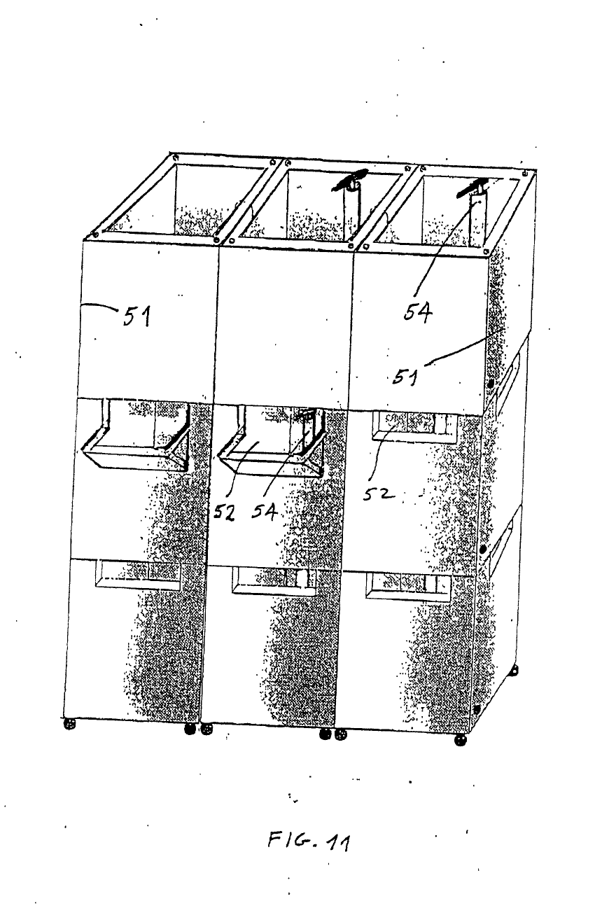

FIGS. 9-11 illustrate stacked planters in accordance with the present invention, forming a column (FIG. 9), or wall partitions (FIGS. 10 and 11). All the planters have straight side walls 51, windows 52 and water pumps 54 and form columns and wall partitions that are opaque.

The planters according to this invention can be made from all kinds of materials, such as plastic, metal, wood, concrete casting or ceramic.

The planters according to this invention may have any desired cross sectional shape. They may be round, oval, half moon shaped, square, rectangular, hexagonal or have any other curved or polygonal shape. Their side walls may be straight vertically or angled inwards or outwards from their cross sectional diameter. Planters made from semi-rigid plastic material can be used to form stacks that bend according to the curvature of the vertical surface against which they are stacked, for example, corners or columns.

A major advantage of the planters of the present invention is that they are simple to manufacture, easy to use, can be placed anywhere in the home or office without fear of water leakage from them. They can be easily rearranged in stacks or individually, and they can form decorative solid partitions.

It will be appreciated by persons skilled in the art that the scope of the present invention is not limited to what has been shown and described hereinabove, merely by way of example. Rather, the scope of the invention is limited solely by the claims which follow.

1. A stackable modular planter comprising a pot having a bottom, side walls and open top, the top edge of at least one side wall having a window for plants to extend therethrough, a water permeable partition divides the pot into an upper plant growing chamber and a lower water collecting and draining chamber having an opening in a side wall for draining water therefrom, said pot further comprising means for integrally supporting a water pump for recycling water from the lower water collecting chamber to the upper plant growing chamber.

2. A planter in accordance with claim 1, comprising between two and four windows in the side walls, to permit passage therethrough of plants from inside the plant growing chamber.

3. A planter in accordance with claim 1 further comprising means for closing said opening for draining.

4. A planter in accordance with claim 1, comprising a window with a lip providing a funnel for introducing water into the plant growing chamber.

5. A planter in accordance with claim 1, wherein the side walls are vertical, enabling positioning containers next to one another without an air space between them.

6. A planter in accordance with claim 1, wherein at least one side wall is at an angle to the bottom surface.

7. A planter as in claim 1, constructed from wood, ceramic, metal or plastic.

8. A planter as in claim 1, wherein said opening for draining comprises a nipple extending out from the side wall.

9. A planter assembly comprising planters in accordance with claim 1.

10. A planter assembly as in claim 9 consisting of a column.

11. A planter assembly as in claim 9 consisting of a wall partition.

12. A planter as in claim 1, wherein the water permeable partition is selected from a metal or plastic net, web or perforated sheet.

13. A planter as in claim 12 wherein the water permeable partition is supported above the bottom surface on protrusions extending inward from the side walls.

14. A stackable planter as in claim 12 wherein the water permeable partition is supported above the bottom surface on legs.

15. A planter as in claim 1, wherein the means for supporting a pump is a shaft extending from the bottom to the top of the planter.

16. A planter as in claim 15 further comprising a water pump inserted in said shaft.

17. A planter as in claim 1 wherein the plant growing chamber is integral with the water permeable partition and comprises an insert for a pot.

18. A planter as in claim 17 wherein a vertical shaft is created by inserting the plant growing insert into a pot.

19. Stackable planters in the form of a column or partition composed of planters as in claim 1.
